(19) United States
(12) Patent Application Publication
(10) Pub. No.: US 2006/0177605 A1
(43) Pub. Date: Aug. 10, 2006

(54) Birefringent optical element, lcd device with birefringent optical element, and manufacturing process for a birefringent optical element

(75) Inventors: Johan Lub, Eindhoven (NL); Bianca Maria Irma Van Der Zande, Eindhoven (NL); Emiel Peeters, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics. N.V., The Netherlands (NL)

(21) Appl. No.: 10/549,025

(22) PCT Filed: Mar. 18, 2004
(86) PCT No.: PCT/IB04/50280

§ 371 Date: Sep. 14, 2005

(30) Foreign Application Priority Data
Mar. 21, 2003 (EP) 03100739.6

(51) Int. Cl. G02F 1/13363; C09K 19/38; G02F 1/1335; C09K 19/02

(52) U.S. Cl. 428/1.3; 428/1.1; 349/121; 349/183; 252/299.01; 349/181

(57) ABSTRACT

A birefringent optical element comprises a polymerized and/or cross-linked mixture (301) of a liquid crystalline compound and a photo-isomerizable compound. The birefringence of the element can be determined with high precision by manipulating the order parameter and polarization anisotropy of said mixture. For this purpose, the photo-isomerizable compound is converted from a transform to a cis-form during manufacturing by means of irradiation. Preferably the photo-isomerizable compound is a cinnamate compound. The irradiated mixture is polymerized and/or cross-linked after irradiation. The irradiation preferably takes place through a greyscale mask (305) so that within the mixture (301) portions (302R, 302G, 302B) are defined that obtain different birefringence values. The process is for example suitable for manufacturing a retarder layer or compensation foil inside the liquid crystalline cell of a Liquid Crystal Display (LCD) device, and in particular for manufacturing a patterned retarder layer having portions with different retardation, associated with the primary colors of a color LCD device.

The invention relates to a birefringent optical element.

The invention further relates to a manufacturing process for an optically birefringent polymer.

The invention further relates to a liquid crystal display (LCD) device comprising a liquid crystalline cell with a retarder layer including such an optical element.

Liquid crystal displays (LCDs) are increasingly the display of choice for a wide range of applications, such as television sets, computer monitors, handheld and automotive devices.

The operation of LCDs is based on light modulation in a liquid crystalline (LC) cell including an active layer of a liquid crystalline material, which cell is sandwiched between a front substrate and a rear substrate. By applying an electric field across the active layer, the light passing through the layer of LC material is modulated.

LCDs are generally operable in one or both of two modes, namely a transmissive mode and a reflective mode. In a transmissive LCD, light originating from a backlight is modulated by the LC layer. An inherent drawback of a transmissive LCD is the dependency of the optical characteristics on the viewing angle, i.e. the angle at which a viewer observes the display. Especially at oblique viewing angles, the displayed image has a reduced contrast ratio and suffers from grey scale inversion.

In a reflective LCD, ambient light is modulated by the LC layer and reflected back towards the viewer. However, the reflective LCD suffers from relatively limited brightness and contrast.

The optical characteristics of LCD devices can be improved by applying one or more layers showing optical birefringence. In a reflective LCD often so-called retarder layers (or foils) are used. The use of retarder layers is nowadays common in for example reflective or transflective LCD panels for use in handheld devices and mobile phones. An example of a commonly employed retarder layer in such devices is a quarter wave retarder, forming circularly polarized light from linearly polarized light or vice versa.

Conventionally, the retarder is formed externally from the LC cell. The retardation is then determined by the retarder thickness d, thus the thickness of the compensation layer is chosen in accordance with the desired retardation. The optically active layer has to be sandwiched in between protection layers, or applied onto a carrier sheet. The optical element thus formed is glued to the substrate of the LC cell. As a result, the LCD device becomes undesirably thick and its optical performance is limited due to parallax.

It is an object of the invention to provide a birefringent optical element, of which the birefringence can be determined with relatively high precision. The optical birefringence Δn is commonly defined as the difference between the material's indices of refraction in the ordinary and extraordinary ray directions.

This object has been achieved by means of the optical element according to the invention as specified in the independent claim 1. Further advantageous embodiments of the optical element are set out in the dependent claims 2-9.

It is a further object of the invention to provide a manufacturing process for a birefringent polymer, during which the birefringence of the manufactured polymer may be particularly well controlled.

This object has been achieved by means of the process as specified in the independent claim 10. Further advantageous embodiments of the process are defined in the dependent claims 11-14.

It is an even further object of the invention to provide a liquid crystal display (LCD) device with a retarder foil, which LCD device has a relatively good optical performance.

This object has been achieved by means of an LCD device as specified in the independent claim 15. Further advantageous embodiments of the LCD device are defined in the dependent claims 16-19.

Thus, an optical element according to the invention has a liquid crystalline compound having a non-twisted nematic or smectic phase and a photo-isomerizable compound present in at least a trans-form. The birefringence of the optical element is dependent on a cis-trans ratio of the photo-isomerizable compound, that is, on the ratio between the amount of the cis-form and the amount of the trans-form in the mixture.

The invention is amongst others based on the recognition that isomerization of the photo-isomerizable compound can advantageously be used for setting the optical birefringence Δn of the polymerized mixture comprising said compound. As is clear from formula (1), changing the optical birefringence Δn influences the retardation R of a layer formed from such a polymer.

During the manufacturing process, the mixture of liquid crystalline compound and photo-isomerizable compound is firstly aligned, so that the directors of the molecules of the compounds are substantially arranged in the same direction. As a result, the aligned mixture shows a relatively high anisotropy of polarisation and a high order parameter.

The order parameter S is defined for a liquid crystalline material as

$$S = \frac{1}{2} 〈 3 {cos}^{2} Θ - 1 〉 , \qquad ( 1 )$$

where Θ represents the angle between the director of a molecule and the normal vector. For an isotropic material S=0, and an order parameter S=1 indicates perfect alignment, i.e. substantially each molecule has its axis aligned with the normal vector.

The alignment step is for example carried out by means of substrate rubbing, photo-alignment or ion beam alignment. Preferably, the alignment is planar, but if an optical element with a tilted optical axis is desired, the alignment should be done accordingly.

Preferably, also the photo-isomerizable compound of the mixture has a non-twisted nematic or smectic phase. In this case, the anisotropy of polarization and the order parameter of the mixture are particularly high.

Optionally, the photo-isomerizable compound and the liquid crystalline compound are the same material, i.e. a single liquid crystalline compound having photo-isomerizable groups may readily be used.

For the mixtures suitable for use with the invention, the anisotropy of polarization and thus the optical birefringence Δn have their highest values when the photo-isomerizable compound of the mixture comprises essentially only the E-isomer (trans-form). This is the mixture's preferred configuration after the aligning step of the manufacturing process according to the invention.

The optical properties of the mixture are then modified by means of a conversion step whereby photo-isomerization takes place. In particular, the isomerization changes the anisotropy of polarization of the mixture. Within this context, the verb “to convert” as used in this patent application should be understood as allowing isomerization to take place, whereby generally at least part of the photo-isomerisable compound is converted from the E-isomer to the Z-isomer (cis-form). The conversion is usually effected by irradiating the photo-isomerisable compound with electromagnetic radiation, preferably UV light. Preferably, the anisotropy of polarisation decreases when the cis-trans ratio between the amounts of the Z-isomer and the E-isomer grows.

Subsequently the modified optical properties are fixed by means of polymerisation and/or cross-linking of the mixture. The obtained polymer has an optical birefringence Δn and may be used for a birefringent optical element.

It is assumed that a change in anisotropy of polarization is caused by the more arcuate shape of the Z-isomer molecules as compared to the E-isomer molecules. The order of the mixture is disrupted by the introduction of the Z-isomer of the photo-isomerizable compound into the mixture. Generally, the introduction of the Z-isomer is assumed to lead to a decrease in polarization anisotropy. Preferably, at least 20% of the photo-isomerizable compound is in the form of the Z-isomer, i.e. the cis-trans ratio is at least 0.25. In this case, the decrease in polarization anisotropy is appreciable.

However, the inventors have found that the invention relies on an additional effect. Namely, the clearing temperature of the mixture decreases upon irradiation. The clearing temperature is the temperature at which the polarization becomes fully isotropic. The order parameter S of the system is reduced by isothermal isomerisation, as this order parameter is amongst others a function of the clearing temperature. This effect takes place in addition to the change in anisotropy of polarization.

By choosing the temperature at which the photo-isomerisation is carried out so that both of these effects occur in combination, the inventors have obtained an unexpectedly large change in optical birefringence.

In preferred embodiments, cyclo addition of part of the compound occurs in addition to the photo-isomerisation, which further influences the optical birefringence.

During the isothermal isomerisation, the birefringence is directly dependent on the time of irradiation. Generally, the birefringence is reduced gradually on a time scale of minutes. Also, the birefringence of the polymer and the retardation of the manufactured optical element are particularly well controllable and the birefringence value can be determined with relatively high precision.

Good results were obtained using a photo-isomerisable compound having an olefinic group, i.e. an unsaturated hydrocarbonic group. Preferably, the olefinic group is a cinnamate compound. The cinnamate compound may further have an aromatic group, or preferably an alicyclic group which gives a higher temperature stability. As an alternative photo-isomerisable compound, a stilbene compound can be used.

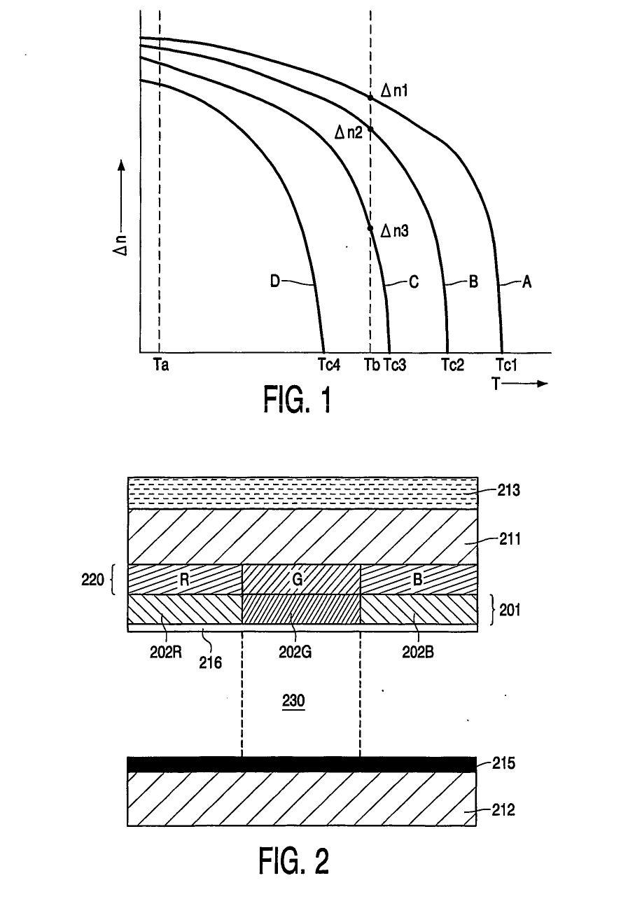

The process should be carried out at a temperature lower than the clearing temperature of the E-isomer of the photo-isomerisable compound (indicated by Tc1 in FIG. 1). For higher process temperatures, the order parameter and the optical birefringence of the mixture are already zero even before starting the conversion from E-isomer to Z-isomer.

Preferably, the process temperature is between 0 and 50 degrees lower than the clearing temperature of the E-isomer.

For process temperatures that are more than 50 degrees below this clearing temperature, the beneficial effect of the decreasing clearing temperature of the mixture is comparatively unnoticeable, and the change in optical birefringence is predominantly determined by the change in anisotropy of polarization. This is the example of temperature Ta in FIG. 1. However, process temperatures more than 50 degrees below the clearing temperature may be useful when the clearing temperature has a relatively high value, such as 200 or 300 degrees Celsius.

More preferably, the process temperature is between 20 and 40 degrees lower than the clearing temperature of the E-isomer. The example of temperature Tb in FIG. 1 should be regarded as being comprised in this process temperature range. In this case, the optical birefringence of the mixture is relatively high before starting the isomerisation step, and the largest change in birefringence can be obtained during the isomerisation.

For example, the clearing temperture is about 70 degrees Celsius and the process temperature is about 35 or 40 degrees Celsius. In this example, the birefringence can be well controlled by choosing the irradiation time, and the required process temperature is only slightly higher than room temperature.

Preferably, the conversion step is carried out under an oxygen containing atmosphere. The presence of oxygen inhibits any preliminary polymerization and/or cross-linking of the mixture caused by the irradiation. As a result, photo-isomerisation is the dominant process.

The manufactured birefringent optical elements can particularly suitably be used in the form of a layer in amongst others an LCD device. The use of such layers is well known in the art. For example, in a reflective LCD a quarter wave retarder is used to convert circularly polarized light to linearly polarized light and vice versa.

Such a layer may also be used as a compensation foil in a transmissive LCD to improve the viewing angle properties of the device. Modern computer monitor and laptop panels commonly employ such a compensation foil.

The retardation R of a birefringent layer is given by the formula:
R=dΔn (2),

wherein d is the thickness of the retarder layer and Δn the optical birefringence of the retarder material.

In order to make a retarder layer or compensation foil in a LCD device, preferably a layer of the mixture is provided on a surface within the LCD device. More preferably, the retarder layer is arranged inside the liquid crystalline cell as this allows for the best possible optical performance. The retarder is then for example provided on a surface of the front substrate, which surface faces the active layer. In a color LCD device, it can be applied directly over the color filter on the side thereof facing the active layer.

The manufacturing process according to the invention is carried out on the mixture layer. The thickness of the layer is known, and the birefringence can be particularly well controlled in the process according to the invention, so that a retarder layer is obtained, of which the retardation very accurately matches a desired retardation. Thus, the retardation may be matched with the optical mode of the liquid crystalline cell as well as possible.

Alternatively, the retarder layer could be manufactured separately from the liquid crystalline cell and glued subsequently to one of the cell's substrates.

According to the invention, the illumination of the mixture may be uniform or non-uniform. In the latter case, different parts of the mixture receive different irradiation doses. As a result, the ratio between cis- and trans-form of the photo-isomerizable compound may vary within the manufactured optical element, leading to a variance in birefringence.

For example, different surface regions of a layer of the mixture receive different amounts of light, so that after polymerization and/or cross-linking a birefringent polymer layer is formed with surface regions having distinct values for the optical birefringence.

Preferably, such non-uniform illumination is carried out using a patterned mask having portions of different transmittance for the radiation being used. By irradiating a layer of the mixture through a patterned mask and subsequently cross-linking and/or polymerizing the layer, a layer provided with a similar pattern as the mask can be manufactured. The inventors have succeeded in manufacturing a patterned retarder layer with a region size of 100 micrometers, but patterning with an even higher resolution should be feasible using the process according to the invention.

This region size is comparable to the size of a picture element of the liquid crystalline cell. As a result, a retarder layer having such patterning can be advantageously used in an LCD by associating the regions of the patterned retarder layer with the (sub)pixels of the LCD device. Since the patterned retarder layer can be applied inside the liquid crystalline cell, this does not lead to parallax effects in the LCD. Patterned retarder layers allow for particularly good optical performance of the LCD device.

In a preferred embodiment, the LCD device is a color LCD device comprising a color filter, the color filter comprising a number of regions being arranged for forming light of a primary color corresponding to that region from the generated light, each portion of the patterned retarder layer being associated with a primary color.

The operation of the retarder is generally dependent on the ratio between the retardation R and the wavelength λ of the incident light. For good performance, the retardation should be matched with that wavelength. For example, if the retardation is 550 nm/4=138 nm, the retarder foil is a quarter wave (λ/4) retarder matched to the wavelength of green light (550 nm). In this case, the retarder foil gives good contrast and brightness for green light, but its performance for red and blue light is worse.

Preferably, the retardation of a portion of the patterned retarder layer is therefore conditional on a wavelength of the light of the associated primary color. If each portion of the patterned retarder is matched with one primary color, the brightness and contrast can be as good as possible for all primary colors.

More preferably, each portion acts as a quarter wave (λ/4) retarder for the light of the primary color associated with that portion.

Such a retarder can be made using the process according to the invention, which can be controlled so that portions of the aligned mixture receive different radiation doses. Thus, the birefringence becomes different for each portion. This structure is polymerized and/or cross-linked, whereby the different birefringence values are fixed and a patterned retarder layer is obtained.

In another preferred embodiment, the LCD device is a transflective LCD device, the liquid crystalline cell of said LCD device comprising a reflective part and a transmissive part, a portion of the patterned retarder layer being associated with said reflective part and a portion of the patterned retarder layer being associated with said transmissive part. For example, the patterned retarder has a quarter wave (λ/4) retardation a for the reflective part and has zero retardation for the transmissive part.

A transflective LCD with a similar structure is disclosed in applicant's international patent application WO 2003/019276.

These preferred embodiments may also be combined, leading to a color transflective LCD device in which a retarder layer is used having zero retardation for the transmissive part of the color sub-pixels and a quarter wave (λ/4) retardation for the reflective part of the color sub-pixels, which quarter wave retardation is matched with the wavelength of light of the corresponding primary color.

The invention will now be elucidated further with reference to the enclosed drawings, which are drawn schematically and not to scale. In the drawings:

FIG. 1 is a phase diagram showing the order parameter versus the temperature, for mixtures that received different radiation doses;

FIG. 2 shows a first embodiment of an LCD device according to the invention;

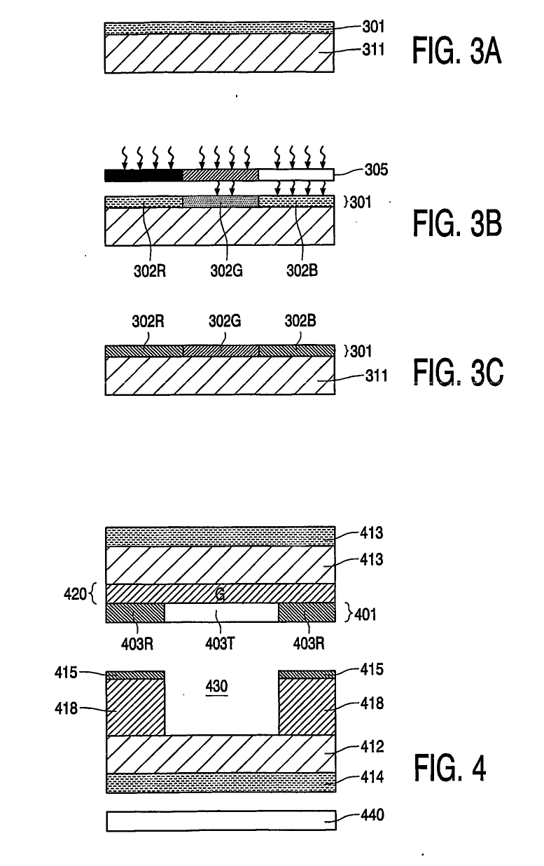

FIG. 3 shows a first embodiment of the manufacturing process according to the invention;

FIG. 4 is a second embodiment of an LCD device according to the invention;

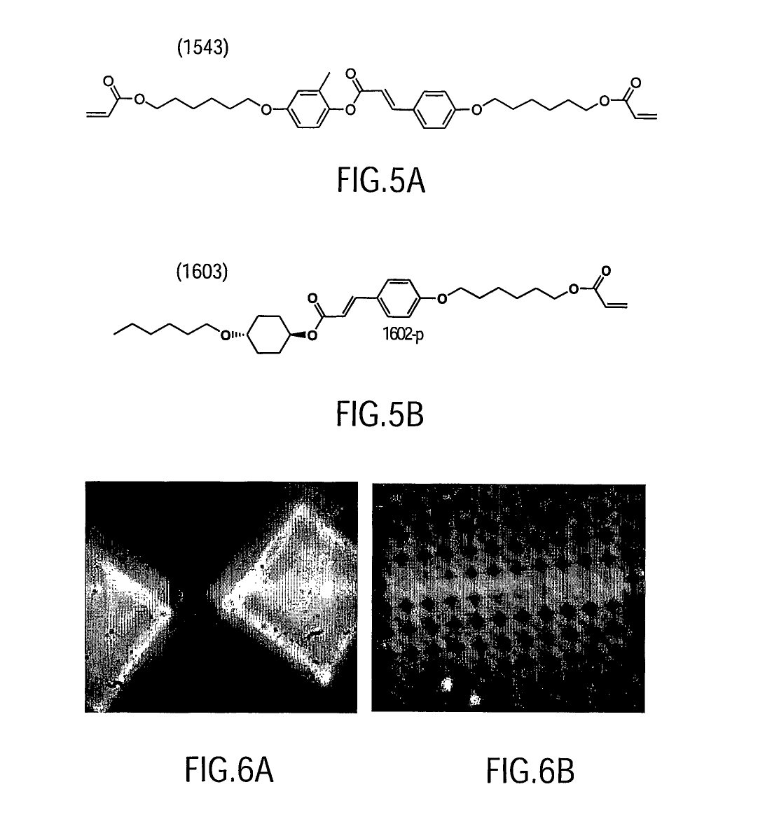

FIGS. 5A and 5B show liquid crystalline cinnamate compounds particularly suitable for use as the photo-isomerizable compound within this invention, and

FIGS. 6A and 6B show photos of a patterned retarder layer, manufactured by means of the process according to the invention.

The combined effects that occur during the converting step, i.e. the reduction in polarization anisotropy by isomerization of the photo-isomerizable compound and the decrease of the order parameter, are firstly elucidated further with reference to FIG. 1, in which the order parameter of the mixture is plotted against the temperature of the system.

The curve indicated by A represents a non-irradiated mixture after the aligning step, wherein the photo-isomerisable compound is essentially fully in its trans-form. The aligned mixture with the photo-isomerizable compound in its trans-form has the highest attainable anisotropy of polarization and the highest clearing temperature Tc1. Irradiation of the mixture causes isomerisation of the photo-isomerisable compound. Thus, part of said compound is converted to the cis-form. The curves indicated by B, C and D represent mixtures that received increasing radiation doses, in that order. Thus the irradiation time is shortest for the curve indicated by B and longest for the curve indicated by D.

At temperatures relatively remote from the clearing temperature Tc1 of the E-isomer, the optical birefringence is hardly influenced by irradiating the mixture. For example at temperature Ta, the optical birefringences for curves A through D are within 10% of each other.

However, for irradiated mixtures the clearing temperature has also decreased. The clearing temperature Tc2 of the mixture represented by curve B is lower than the clearing temperature Tc1 of the E-isomer, the clearing temperature Tc3 of the mixture represented by curve C is again lower than Tc2 and the clearing temperature Tc4 of the longest irradiated mixture represented by curve D is again lower than Tc3.

For example, for a process temperature Tb, it can be seen in FIG. 1 that the optical birefringence before irradiation is Δn1, and that the optical birefringence is reduced by irradiating the mixture and thus converting the photo-isomerisable compound.

In this example, the optical birefringence is Δn2 for the mixture represented by curve B, and Δn3 for the mixture represented by curve C. The temperature Tb is chosen higher than the clearing temperature Tc4 of the mixture represented by curve D, thus in that case the isotropic transition has occurred. The optical birefringence is thus zero.

The clearing temperature Tc1 when the photo-isomerizable compound is fully in trans-form is for example about 70 degrees Celsius, and a suitable process temperature Tb is for example 35 or 40 degrees Celsius.

A practical example of carrying out the manufacturing process according to the invention is set out in the following.

### EXAMPLE 1

A reactive liquid crystal mixture was made by dissolving

0.5 g 1,4-di(4-(3-acryloyloxypropyloxy)benzoyloxy)-2-methylbenzene (ex Merck),

0.5 g 4-(6-acryloxy-hexyloxy)-2-methyl-phenyl-4-(6-acryloyloxyhexyloxy)cinnamate,

0.05 g Irgacure 651 (αα-dimethoxydeoxybenzoin) ex Ciba Geigy, Switzerland, and

0.05 g (2-n-ethylperfluoro-octanesulfonamido)-ethylacrylate containing 100 ppm inhibitor

in 4 g xylene at a temperature of 70° C.

1,4-di(4-(3-acryloyloxypropyloxy)benzoyloxy)-2-methylbenzene is a reactive liquid crystalline monomer.

4-(6-acryloxy-hexyloxy)-2-methyl-phenyl-4-(6-acryloyloxyhexyloxy)cinnamate is a reactive liquid crystalline monomer that photo-isomerizes. This compound is shown in its trans-form in FIG. 5A and referred to by “1543” in the drawing as well as in the following text.

Furthermore, the mixture comprises a photoinitiator, Irgacure 651, and a surfactant to obtain planar alignment of the liquid crystalline monomers, (2-n-ethylperfluoro-octanesulfonamido)-ethylacrylate, which is commercially available from Across.

This mixture was spincoated on top of an alignment layer, being a rubbed polyimide. The spincoating was carried out for 30 seconds at 1000 rpm, and subsequently for another 30 seconds at 3000 rpm. The rubbed polyimide establishes a planar alignment in a monodomain of the LC monomers in the rubbing direction. The maximum order parameter of the LC monomers is obtained, resulting in a retardation of about 100 nm.

The order parameter is subsequently decreased patternwise by a mask exposure to UV light with a wavelength of 365 nm (HPA lamp, 4 mW/cm²) in air. The temperature during exposure is about 35-40° C. The irradiation was carried out for about 20 minutes.

By means of this irradiation with UV light, the 1543 cinnamate compound isomerises. The presence of oxygen inhibits any polymerization, allowing for the occurrence of only isomerization.

As a result, in the mixture the order of the mesogens is disrupted by the introduction of the cis-form of the cinnamate compound, which is the photo-isomerisable compound in this example.

In addition, and what is probably the most important parameter for orientational loss, the clearing temperature is decreased as illustrated in FIG. 1, in this example from 75° C. to 50° C. Due to the gradual shift in clearing temperature the birefringence of the mixture can be controlled with high precision using the exposure time. If a retardation value of zero is desired, the irradiation should be continued longer, until the isotropic state is reached. The clearing temperature has then become lower than the temperature at which the process is carried out.

Finally the obtained order in the exposed and unexposed parts is permanently fixed by UV exposure for 10 minutes under a nitrogen atmosphere. Due to the rapid photo-polymerization process the applied UV light during this step has no noticeable effect on the optical properties. If necessary, the photo-polymerization may be followed by further thermal isomerization.

The structure finally obtained is a patterned birefringent layer, having areas for which different birefringence values are measured. The pattern of the layer matches the pattern of the mask applied during the mask exposure.

### EXAMPLES 2-8

A similar mixture was prepared as in Example 1, wherein the 1543 cinnamate compound was replaced with the 1602 cinnamate compound shown in FIG. 5B in its trans-form. The aromatic group of the 1543 compound is substituted with an alicyclic group in the 1602 compound

In each of these Examples 2 through 8, the mixture with the 1602 cinnamate compound was irradiated for a different irradiation time after alignment. The irradiated mixture was polymerized in a similar way as in Example 1.

The obtained retardation and the amount of the cis-form (Z-isomer) in the irradiated mixture were measured. The results are given in Table 1. The retardation is also dependent on the layer thickness which is well determined by the spincoating conditions set out in the above.

TABLE 1

| | UV irradiation time | Retardation | Relative occurrence |
|---|---|---|---|
| | @ 4 mW/cm² | (nm) | of 1602-cis (Z-isomer) |
| Example 2 | 0 min | 171 | 0% |
| | | | (pure 1602-trans) |
| Example 3 | 2 min | 130 | 29% |
| Example 4 | 5 min | 75 | 38% |
| Example 5 | 10 min | 62 | 41% |
| Example 6 | 15 min | 48 | 41% |
| Example 7 | 20 min | 24 | 41% |
| Example 8 | 30 min | 0 | 44% |
| | | (isotropic | |
| | | mixture) | |

It can be seen that the retardation gradually decreases over the irradiation time. From an initial value of 171 nm, an isotropic mixture is obtained after 30 minutes using this mixture composition, layer thickness and radiation intensity.

Birefringent optical elements manufactured in this way are particularly applicable in Liquid Crystal Displays. Layers of birefringent material can be used as retarder layers in reflective LCDs, or as compensation foils in transmissive LCDs. A first embodiment of a liquid crystalline cell for a LCD is shown in FIG. 2. The LCD device further comprises driver electronics not shown in the drawing. It is noted that the drawing only shows one color pixel, i.e. three primary color sub-pixels, whereas an actual Liquid Crystal Display has a large number of pixels, for example 320×240 color pixels and thus 960×240 sub-pixels.

The LC cell illustrated here is a reflective cell based on the Twisted Nematic (TN) effect. An electric field may be applied perpendicularly to the liquid crystalline (LC) layer 230 by applying a voltage difference across the reflective electrode 215 and the transmissive electrode 216, usually an indium tin oxide (ITO) electrode.

When zero voltage or a minimum driving voltage is applied, unpolarized ambient light incident onto the device passes through a linear polarizer 213 on substrate 211, the color filter 220 and a λ/4 retarder layer 201 before entering the LC layer 230. The color filter 220 selectively allows linearly polarized light of the different primary colors to pass through the color filter regions associated with the primary colors (indicated by R, G and B in the drawing).

Thus, linearly polarized light that is separated into the primary colors is obtained. This linearly polarized light is then circularly polarized by the retarder layer 201, before entering the LC layer 230. On the other side of the LC layer 230, the reflective electrode 215 including a so-called internal diffusive reflector (IDR) is arranged which reflects and diffuses incident light that passed through the LC layer 230 back towards a viewer.

An initial twist angle of the liquid crystal molecules is for example 90 degrees. Without any voltage, the twisted LC layer 230 causes the circularly polarized light to be linearly polarized when it arrives at the reflector 215. This light is then reflected back, and regains its original circular polarization when arriving at the 24 retarder 201. The λ/4 retarder 201 converts the circularly polarized light back to linearly polarized light having its original polarization direction so that it is able to pass back through the polarizer 213 and exit the cell towards a viewer.

However, when a maximum driving voltage is applied between the electrodes 215 and 216, the liquid crystalline cell is changed to its dark state.

The liquid crystal molecules align with the applied electric field, and the initial twist angle of the molecules disappears. Thus, the circularly polarized light exiting from the λ/4 retarder 201 passes through the LC layer 230 and thereby effectively experiences a low birefringence. Consequently the light is still circularly polarized when it arrives at the reflector 215. Upon reflection, the circular polarization is reversed causing the light to have an opposite circular polarization. The light still has this opposite circular polarization when arriving at the λ/4 retarder 201 and therefore the λ/4 retarder 201 now converts the light to a linear polarization state having a polarization direction perpendicular to the original linear polarization direction. Thus, this linearly polarized light has a polarization direction perpendicular to the polarization axis of the polarizer 213 and is absorbed by the polarizer 213. No light exits from the liquid crystalline cell so that a viewer observes a dark state.

In this embodiment, the retarder layer 201 is a patterned retarder layer that has three regions 202R, 202G, 202B. In each region, the retardation of the quarter wave retarder is matched with the wavelength of one of the primary colors red, green and blue. In particular, the retardation is matched with the wavelength of the primary color associated with the adjacent color filter region. In the following, this configuration will be referred to as a “color-patterned retarder layer”.

When a retarder with a constant retardation is used, the retarder is usually optimized for green light, for example the retardation is (550/4)=138 nm. A liquid crystalline cell of the electrically controlled birefringence (ECB) type, incorporating such a retarder, has for example a contrast ratio of 17 for green. However, the contrast ratio for red is only 7, and the contrast ratio for blue is as small as 6. The ECB cell includes an active layer of a non-twisted nematic liquid crystalline material with planar alignment.

In the first embodiment of the LCD device according to the invention, the retardation of the retarder layer 201 is adapted for each primary color, i.e. the retardation is 138 nm for the green region 202G, (650/4)=163 nm for the red region 202R, and (450/4)=112 nm for the blue region 202B.

The contrast ratio of the ECB cell is now relatively high for all primary colors. For example, the contrast ratio for green is still 17, but for red it increases to 11 and for blue to 9. As a result, an increase in contrast ratio of 50% is obtained for the red and blue sub-pixels.

Such a color-patterned retarder may readily be manufactured by means of the process according to the invention, wherein a patterned mask is used that comprises white (fully transmissive for the applied radiation), grey (partly transmissive/reflective) and black (fully reflective for the applied radiation) areas.

A suitable embodiment of this process is illustrated in FIGS. 3A-3C. A layer 301 of the mixture of the liquid crystalline compound and the photo-isomerizable compound is spincoated on a rubbed substrate 311 and thereby aligned (FIG. 3A). The mixture composition and spincoating conditions correspond to those in the Example set out earlier.

Now, during the converting step (FIG. 3B) different regions 302R, 302G, 302B of the layer 301 receive different radiation doses of the applied UV light. Particularly, the region 302R corresponding to red receives substantially no radiation so that the photo-isomerizable compound within that region 302R remains substantially in its trans-form. For this purpose, the black area of the patterned mask 305 is associated with the region 302R corresponding to the primary color red (650 nm wavelength).

The white area of the mask 305 is associated with the region 302B corresponding to the primary color blue (450 nm wavelength). The radiation dose is chosen such that the mixture in the region 302B decreases in birefringence by a factor of about 1.45. The grey area of the mask is associated with the region 302G corresponding to the primary color green. The greyscale of the grey area of mask 305 is chosen such that the region 302G receives only part of the radiation dose, such that the mixture birefringence within said region 302G is reduced by a factor of about 1.2.

After irradiation, the mixture layer 301 is cross-linked and polymerized (FIG. 3C). The atmosphere is changed to nitrogen or alternatively a noble gas atmosphere such as argon. Photo-polymerization is now initiated by means of a flood UV irradiation. This photo-polymerization process is generally followed by thermal polymerization, in this case a baking step is carried out during which the layer is heated to 150 degrees Celsius for about 2 hours.

Thus, a color-patterned retarder layer for an LCD device can be manufactured, using only a single mask step. In this example, a mask with three areas having different transmittance was used, corresponding to the three primary colors of a conventional color LCD device. However, a color-patterned retarder for a multi-primary LCD device, i.e. a LCD device with more than three primary colors, is easily manufacturable by using a mask with a corresponding number of areas of different transmittance.

In general, using similar processes, a retarder layer with any desired patterning can be envisaged, where the birefringence of the different regions may vary within a relatively large range. In the case of a retarder layer, the layer thickness is essentially the same for the different regions. The different retardation of the different regions is predominantly determined by the different birefringence values.

An example of a quarter-wave retarder with a further improved contrast ratio is based on the wide-band quarter-wave retarder already known for several decades [S. Pancharatnam, Proc. Indian Ac. Sci. XLI, no. 4, sec. A (1955)].

The wide-band quarter-wave retarder comprises a combination of a half-wave plate with its optical axis at 15° to the polariser direction and a quarter-wave retarder with its optical axis at 75° to the polariser direction. In this case the leakage in the dark state is already considerably reduced as compared to that of a simple quarter-wave retarder. An ECB cell incorporating such a wide-band retarder has for example a contrast ratio of 155 for green, whereas the contrast ratio for red may be only 60, and the contrast ratio for blue may be as small as 46.

Also in this example, the contrast ratio is improved by optimizing the retardation value for the half-wave retarder and the quarter-wave retarder for each color sub-pixel. By adapting the retardation for each primary color, the contrast ratio for green is still 155, but for red it increases to 107 and for blue to 88.

A second embodiment of an LCD device has a so-called transflective liquid crystalline cell which is shown in FIG. 4. The transflective LC cell comprises a reflective part and a transmissive part, the transmissive part usually being enclosed within the reflective part. FIG. 4 shows one primary color sub-pixel (in this case green) of the transflective LC cell. The operation of the reflective part is similar to that of the LC cell in the first embodiment. The reflector 415 is arranged on top of a planarization layer 418, which causes the cell gap of the LC cell to be different for the reflective and transmissive parts. In addition, the optical properties of the parts can be properly matched.

For the transmissive part, light from a backlight 440 is incident on the LCD device and linearly polarized by a rear polarizer 414 having its polarization axis perpendicular to that of the front polarizer 413. The linearly polarized light then passes through substrate 412 into the liquid crystalline layer 430. The layer has for example a 90 degree twist, so that the polarization vector of the linearly polarized light is rotated through 90 degrees in the LC layer 430. The light then passes retarder layer 401, color filter 420, and front substrate 411. Because of the twist angle of the LC layer 430, the polarization vector of the linearly polarized light now matches with the polarization axis of the front polarizer 413. The linearly polarized light is therefore able to pass the polarizer 413 and exit from the liquid crystalline cell towards the viewer.

Instead, if an electric field is applied perpendicularly to the LC layer 430 (electrodes not shown here), the polarization vector of the linearly polarized light exiting the rear polarizer 414 is not rotated by the LC layer 430. Thus, the polarization vector of this linearly polarized light is perpendicular to the polarization axis of the front polarizer 413 and as a result the light is blocked by the front polarizer 413.

For the transmissive part, a birefringent layer is not required in this case. Therefore, the in-cell retarder layer 401 is a patterned retarder layer which has a reflective part 403R having a retardation of λ/4, and a transmissive part 403T which is isotropic, i.e. has zero retardation.

This structure can easily be obtained by means of the manufacturing process according to the invention. After the aligning step, the reflective part 403R of the retarder layer 401 is masked and the transmissive part 403T irradiated so that photo-isomerisation takes place. The irradiation is continued until the clearing temperature of the mixture in the transmissive part 403T has decreased below the processing temperature. This part of the mixture has then become isotropic, and the patterning of the retarder layer 401 is again fixed by means of polymerization and/or cross-linking.

To demonstrate the feasibility of this, such a structure was placed between crossed polarizers and illuminated from the back. In this case, the transmissive part 403T absorbs all incident light and the reflective part 403R transmits a portion of the incident light. FIG. 6 shows photographs of this, for structures having a pattern size of 1 mm (FIG. 6A) and 100 μm (FIG. 6B).

In the second embodiment of the LC cell, alternatively, a compensation foil could be glued to the substrate 412 on the backlight side, and the transmissive part 403T could have a non-zero retardation.

The drawings are schematic and not drawn to scale. While the invention has been described in connection with preferred embodiments, it should be understood that the invention should not be construed as being limited to the preferred embodiments. Rather, it includes all variations which could be made thereto by a skilled person, within the scope of the appended claims. The use of the birefringent optical elements as disclosed in this patent application is not limited to LCD devices, and may be imagined to include any optical system wherein birefringent elements are applied.

In summary, a birefringent optical element is disclosed comprising a polymerized and/or cross-linked mixture (301) of a liquid crystalline compound and a photo-isomerizable compound. The birefringence of the element can be determined with high precision by manipulating the order parameter and polarization anisotropy of said mixture. For this purpose, the photo-isomerizable compound is converted from a trans-form to a cis-form during manufacturing, preferably by means of irradiation. Preferably the photo-isomerizable compound is a cinnamate compound. The irradiated mixture is polymerized and/or cross-linked after irradiation. The irradiation preferably takes place through a greyscale mask (305) so that within the mixture (301) portions (302R, 302G, 302B) are defined that obtain different birefringence values. The process is for example suitable for manufacturing a retarder layer or compensation foil inside the liquid crystalline cell of a Liquid Crystal Display (LCD) device, and in particular for manufacturing a patterned retarder layer having portions with different retardation, associated with the primary colors of a color LCD device.

1. A birefringent optical element comprising a cross linked and/or polymerized mixture of
a liquid crystalline compound having a non twisted nematic or smectic phase, and
a photo-isomerizable compound, at least one of the compounds including a polymerizable group,
wherein the photo isomerizable compound is present in at least a trans form, and a birefringence value is dependent on a cis trans ratio of the photo isomerizable compound.

2. The optical element of claim 1, wherein
the birefringence value substantially decreases with an increase in the cis trans ratio.

3. The optical element of claim 1, wherein
part of the photo-isomerizable compound is converted by means of a cyclo-addition process further influencing the birefringence value

4. The optical element of claim 1, wherein
the cis trans ratio is at least 0.25.

5. The optical element of claim 1, wherein
the photo-isomerizable compound has a non twisted nematic or smetic phase.

6. The optical element of claim 1, wherein
the photo-isomerizable compound and the liquid crystalline compound are the same material.

7. The optical element of claim 1, wherein the photo-isomerizable compound comprises an olefinic group.

8. The optical element of claim 7, wherein the photo-isomerizable compound is a cinnamate compound.

9. The optical element of claim 8, wherein the cinnamate compound further includes an aromatic or alicyclic group.

10. A manufacturing process for an optically birefringent polymer, including the steps of
providing a mixture of a liquid crystalline compound having a non twisted nematic or smectic phase and a photo-isomerizable compound, at least one of the compounds including a polymerizable group;
aligning the mixture;
converting the photo isomerizable compound at a temperature lower than a clearing temperature of a trans form of the photo isomerizable compound, and
cross linking and/or polymerizing the mixture after the converting step.

11. The manufacturing process of claim 10, wherein the converting step is carried out at a temperature between 0 and 50 degrees below a clearing temperature of the E isomer of the photo isomerizable compound.

12. The manufacturing process of claim 11, wherein the converting step is carried out at a temperature between 20 and 40 degrees below the clearing temperature of the E isomer of the photo isomerisable compound.

13. The manufacturing process of claim 10, wherein the step of converting the photo isomerizable compound comprises irradiating the mixture through a patterned mask having portions of different transmittance for the radiation being used.

14. The manufacturing process of claim 10, wherein the converting step is carried out under an oxygen containing atmosphere.

15. A Liquid Crystal Display (LCD) device, comprising a liquid crystalline cell for receiving and selectively passing incident light, said cell being sandwiched between a front substrate and a rear substrate, wherein said LCD device further comprises a retarder layer including a birefringent optical element according to claim 1.

16. The LCD device of claim 15, wherein the retarder layer is a patterned retarder layer comprising portions each having a different optical birefringence.

17. The LCD device of claim 16, wherein the LCD device is a color LCD device comprising a color filter, the color filter having regions (R,G,B) being arranged for forming light of a primary color corresponding to that region from the incident light, each portion of the patterned retarder layer being associated with a primary color.

18. The LCD device of claim 17, wherein the retardation of the portion of the patterned retarder layer is conditional on a wavelength of the light of the associated primary color.

19. The LCD device of claim 16, wherein the LCD device is a transflective LCD device, the liquid crystalline cell of said LCD device comprising a reflective part and a transmissive part, a portion of the patterned retarder layer being associated with said reflective part and a portion of the patterned retarder layer being associated with said transmissive part.

20. Use of a cinnamate compound in manufacturing a birefringent optical element.
